(19) United States
(12) Patent Application Publication
(10) Pub. No.: US 2005/0022380 A1
(43) Pub. Date: Feb. 3, 2005

(54) Steering gear pitman-arm spreader tool

(75) Inventors: Donald D. Reid, Nashville, TN (US); Michael L. Whitehead, Clarinda, IA (US)

Correspondence Address: BANNER & WITCOFF, LTD., TEN SOUTH WACKER DRIVE, SUITE 3000, CHICAGO, IL, 60606, US

(73) Assignee: The Lisle Corporation, Clarinda, IA (US)

(21) Appl. No.: 10/629,944

(22) Filed: Jul. 30, 2003

(51) Int. Cl. B23P 19/04; B23P 6/00

(52) U.S. Cl. 29/888.011; 29/253; 29/261

(57) ABSTRACT

A tool to facilitate removal of a pitman-arm mounted on a shaft includes a main frame member with a threaded center drive rod and radially spaced, depending retention arms pivotally suspended from the frame member. Rotation of the threaded drive rod causes a wedge section at the leading end of the drive rod to separate the legs of the pitman-arm as the retention arms hold the tool in place on the pitman-arm.

### BACKGROUND OF THE INVENTION

In a principal aspect, the present invention relates to a tool especially useful for the removal of a steering gear pitman-arm from a shaft, more particularly a steering gear pitman-arm of the type having opposed slightly spaced legs wherein the legs define a shaft opening and the arm is retained on the shaft by means of a bolt which is positioned in a bore adjacent to and transverse to the shaft opening in the pitman-arm.

Pitman-arms of various size and configuration are utilized in vehicles to transfer motion, for example, rotary motion to longitudinal motion. Typically the pitman-arm includes a throughbore or passage capable of receiving a shaft, for example, a driving shaft. One end of the arm is mounted on the shaft and the opposite end of the arm is attached to another element of the vehicle. Pitman-arms utilized in larger or heavy duty vehicles are massive; being not only structurally large, but quite heavy and cumbersome. Typically such pitman-arms include a shaft opening defined by a pair of opposed, slightly spaced legs. The arm is mounted on a shaft and retained thereon by means of a bolt located in a bore through the legs adjacent to and transverse to the shaft. The bolt tightens the legs on the shaft.

When repairing or servicing a vehicle having a heavy duty pitman-arm, it is often desirable to remove the pitman-arm. This is initially accomplished by removing the retention bolt. However, corrosion of the component parts of the vehicle may preclude ease of removal of the pitman-arm from the shaft. Therefore additional leverage is required. For example, some mechanics will attempt to drive a hand wedge between the arms forming the shaft opening in the pitman-arm. This, however, is considered to be somewhat dangerous inasmuch as the wedge may slip from its position and is not easily guided when attempting to spread the legs. Thus, there has developed a need for a tool which will facilitate removal of a pitman-arm of a type having opposed legs defining a shaft opening.

### SUMMARY OF THE INVENTION

Briefly, the present invention comprises a tool for spreading the opposed legs of a pitman-arm wherein those legs include or define a shaft opening for attachment of the arm to a shaft. The tool includes a cross bar frame member with a center drive rod projecting axially through the frame member and lateral depending arms pivotally attached to the frame member. The arms include pin or rod sections designed to fit into the bolt bore in the end of the legs of the pitman-arm. A wedge member is provided at the end of the drive rod. The wedge member of the drive rod may then be inserted in the small opening or slot between the legs of the pitman-arm and driven or wedged between those legs by turning the threaded drive rod to spread the legs slightly so that the pitman-arm may be more easily removed from the shaft on which it is mounted.

Thus it is an object of the invention to provide a tool which will facilitate removal of a pitman-arm from a shaft on which that arm is mounted.

It is a further object of the invention to provide a tool which can be used in a manner considered to be safer than the prior art methodology of hand-driving a wedge between legs associated with the pitman-arm.

Another object of the invention is to provide a tool that facilitates removal of a pitman-arm from a shaft which is easy to use, economical and rugged.

These and other objects, advantages, and features of the invention will be set forth in greater detail in the description which follows.

### BRIEF DESCRIPTION OF THE DRAWING

In the detailed description which follows, reference will be made to the drawing comprised of the following figures:

FIG. 1 is a plan view of the tool of the invention;

FIG. 2 is a plan view of a depending leg which is incorporated in the tool of FIG. 1 as viewed from a side thereof;

FIG. 3 is a plan view of the frame member of the tool of FIG. 1 as viewed along the top end or edge of the tool;

FIG. 4 is an exploded view of the drive rod or pusher bolt and wedge section or wedge member associated therewith;

FIG. 5 is an isometric view of a typical pitman rod as mounted on a shaft;

FIG. 6 illustrates the method of use of the tool of FIG. 1 with respect to removal of a pitman rod of the type shown in FIG. 5; and

FIG. 7 is another prospective view illustrating the use of the tool of FIG. 1.

### DESCRIPTION OF THE PREFERRED EMBODIMENT

Referring to FIGS. 1-4, there is depicted a tool which is used to practice the method of the invention. The tool is comprised of a cross bar frame member 10 which has a first depending arm 12 pivotally attached to one side thereof and a second depending arm 14 attached to the opposite side thereof. The cross bar frame member 10 includes a threaded center throughbore 16 having a drive member or rod or pusher bolt 18 threaded therethrough and moveable along an axis 20 in response to turning bolt 18 in the threaded passage 16. The bolt or drive rod 18 includes a polygonal or hexagonal cross section drive end 22, a threaded rod or center section 24 and a ball-shaped forward end 26. Attached to the ball-shaped forward end 26 is a spreader or wedge section or assembly 28 which includes a leading edge wedge 29 and a counterbore 31 to receive end 26. A locking pin or washer 35 fits into a slot 38 to retain the wedge member 28 on the drive rod 118 ball end 26. Thus the wedge member 28 may be freely rotated about the axis 20 and may also move a certain limited amount about the axis 20 so as to align effectively between the legs of a pitman-arm.

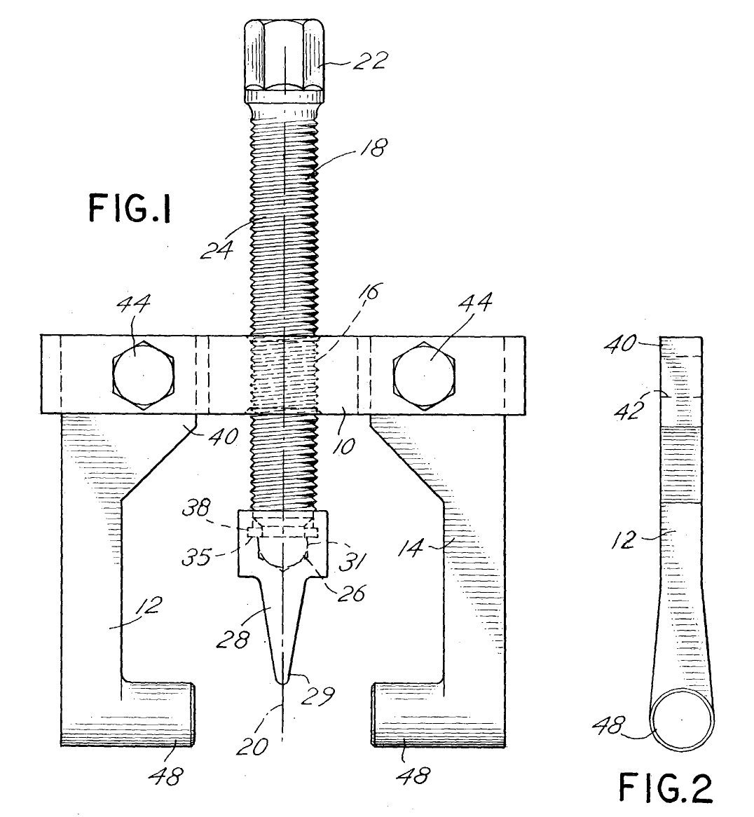

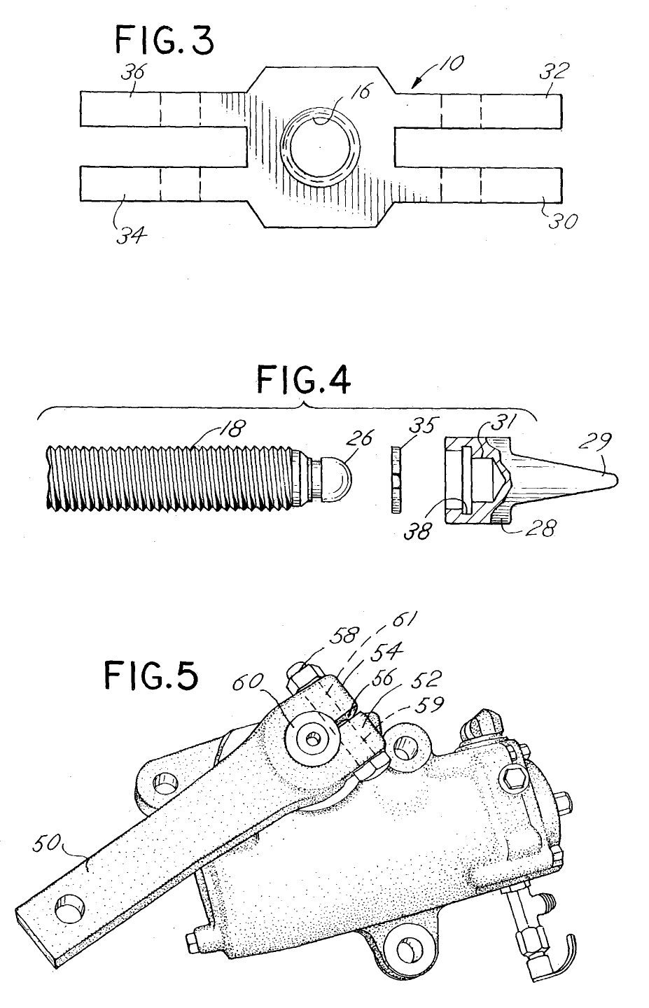

The depending arms 12, 14 are mounted respectively equally from and on opposite sides of the centerline axis 20 in the frame member 10. Thus, the frame member 10 includes a first pair of generally radially extending arms 30, 32 defining a first yoke and a second pair of generally radially extending arms 34, 36. The arms 34, 36 extend in opposite directions respectively from the arms 30, 32. As depicted in FIG. 3, the arms 30, 32, 34, 36 are symmetrical with respect to the axis 20. The arms 30, 32 as well as the arms 34, 36 are spaced one from the other so that the depending arms 12, 14 and, more particularly, the attachment ends 40 of the depending arms 12, 14 may be fitted between the legs 30, 32 or 34, 36 as the case may be. Thus referring to FIG. 2, the depending arms 12, 14 each include an end 40 having a through passage 42 for receipt of a bolt or a fastener 44 to retain the depending arm 12 or 14 on the frame member 10. The opposite or distal end of the depending arms 12, 14 include a rod section 48 which is adapted to fit into a fastener bore associated with the pitman-arm as described hereinafter. The rod sections 48 are opposed one to the other as depicted in FIG. 1. Thus, the arms 12, 14 pivot freely about the respective bolts 44 so that the rod sections 48 may be inserted into bores of the pitman-arm. Note that the rod sections 48 are generally in the same plane as the axis 20. Thus, all of the component elements are aligned and symmetrical.

FIGS. 5, 6 and 7 illustrate the manner of operation of the tool depicted in FIGS. 1-4. Thus, a pitman-arm 50 includes first and second legs 52, 54 which are spaced one from the other and include a slot 56 therebetween with a bolt 58 mounted in bores 59, 61 defined in the rod legs 52, 54 to retain the pitman-arm 50 on a shaft 60. The shaft 60 is typically a splined shaft and the passage for the shaft in the pitman-arm 50 is likewise splined to enable the shaft 60 to be fixed to the pitman-arm and move in a manner which will rotatably drive the pitman-arm 50 or alternatively, the pitman-arm 50 will rotatably drive the shaft 60.

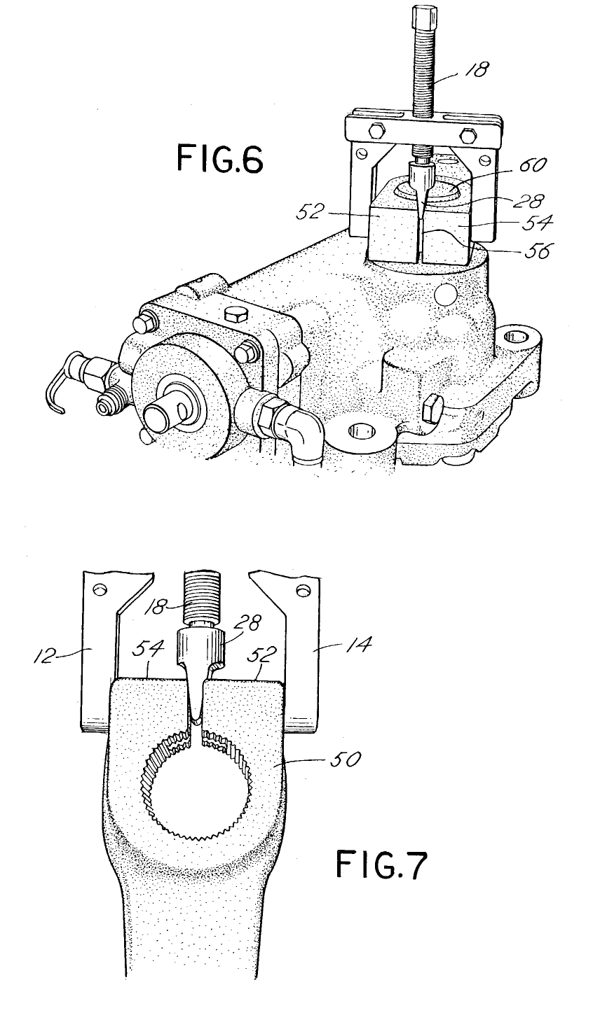

To remove the pitman-arm 50 from the shaft 60 is often difficult inasmuch as the arm 50 may become somewhat corroded on the shaft 60. Thus by using the tool of the invention, the legs 52, 54 of arm 50 may be slightly spread or at least disengaged from shaft 60 in a manner which will permit the shaft 60 and the arm 50 to be easily disengaged. As depicted in FIG. 6, the rod sections 48 are inserted through the bore 59, 61 associated with the bolt 58 that has been removed from the pitman-arm 50. The wedge section 28 may then be driven into the space 56 between the legs 52, 54 by axial movement of the drive rod 18. Note that the orientation of the tool depicted in FIG. 6 is not limiting. In FIG. 6 the orientation is such that the axis of the drive rod 18 aligned with the axis of the shaft 60. It is possible, however, that the axis of the shaft 18; namely, axis 20 may be transverse to the axis of the shaft 60. This alternative alignment is depicted in FIG. 7 wherein the pitman-arm 50 has been removed from a shaft 60 and is in the process of being replaced. Thus, the tool of the invention may be used to spread the legs 52, 54 so as to effect a slight opening thereof for ease of replacement of the pitman-arm 50 on a shaft 60.

While there has been set forth a preferred embodiment of the invention, various alternative constructions are possible within the spirit and scope of the invention. For example, the configuration and shape of the depending arms 12, 14 may be altered. The construction of the frame 10 may be altered. The construction of the wedge member 26 as well as the means for driving the wedge member, including the drive rod may be altered using other drive means

1. A tool for spreading the opposed legs of a pitman-arm of the type having a shaft passage between the opposed legs, said tool comprising, in combination:
a cross bar frame member having a centerline axis, a first lateral arm extending radially from the axis and a second lateral arm extending in the opposite direction from the lateral first arm;
a first depending arm pivotally attached at one end to the first lateral arm at a first radial distance from the axis and generally extending in an axial direction;
a second depending arm pivotally attached at one end to the second lateral arm at a second radial distance from the axis and extending in the same axial direction as the first depending arm;
each of said depending arms including a rod section extending radially inward toward the axis, said rod sections generally opposed to each other;
a drive rod axially extending through the cross bar frame member and axially adjustable in the frame member, said drive rod including a leading end wedge section aligned intermediate the depending arms whereby the rod sections may be simultaneously positioned in a fastener bore in a pitman-arm as the wedge section is positioned and driven intermediate the opposed legs by axial drive rod movement to effect leg separation.

2. The tool of claim 1 wherein the drive rod includes a polygonal head and the drive rod is threaded in the cross bar frame member.

3. The tool of claim 1 wherein each of the lateral arms are comprised of a yoke with a pivot element connecting the respective depending arms.

4. The tool of claim 1 wherein the wedge section comprises a separate wedge element pivotally mounted at the leading end of the drive rod.

5. The tool of claim 4 including a lock washer to retain the wedge element on the drive rod.

6. A method for removal of a pitman-arm of the type having a shaft passage between opposed legs said legs including a fastener bore therethrough transverse to the shaft passage comprising the steps of:
positioning a tool having a cross bar frame member having a centerline axis, a first lateral arm extending radially from the axis and a second lateral arm extending in the opposite direction from thelateral first arm;
a first depending arm pivotally attached at one end to the first lateral arm at a first radial distance from the axis and generally extending in an axial direction;
a second depending arm pivotally attached at one end to the second lateral arm at a second radial distance from the axis and extending in the same axial direction as the first depending arm;
each of said depending arms including a rod section extending radially inward toward the axis, said rod sections generally opposed to each other;
a drive rod axially extending through the cross bar frame member and axially adjustable in the frame member, said drive rod including a leading end wedge section aligned intermediate the depending arms whereby the rod sections may be simultaneously positioned in a fastener bore in a pitman-arm as the wedge section is positioned and driven intermediate the opposed legs by axial drive rod movement to effect leg separation
with said wedge section intermediate the pitman-arm legs and the rod sections in the fastener bore moving the drive rod to drive the wedge section between the legs; and
removing the pitman-arm from the shaft.
